(19) United States
(12) Patent Application Publication
(10) Pub. No.: US 2005/0246227 A1
(43) Pub. Date: Nov. 3, 2005

(54) Game card based business method

(75) Inventors: Maria Clancy, Bal Harbour, FL (US); Louis Marzetti, Bal Harbour, FL (US)

Correspondence Address: LERNER AND GREENBERG, PA, P O BOX 2480, HOLLYWOOD, FL, 33022-2480, US

(73) Assignee: Bernie Charles, Inc.

(21) Appl. No.: 10/836,144

(22) Filed: Apr. 30, 2004

(51) Int. Cl. G06F 17/60

(52) U.S. Cl. 705/14; 705/1

(57) ABSTRACT

A method for conducting a promotional game includes ringing up a purchase of goods and/or services being purchased by a store customer. A game card is then sold or given to the store customer as a last item rung up for the store customer. A game card is electronically printed and contains indicia indicative of a purchase value. The respective game card is given to the store customer for ascertaining if the game card is a winning game card. The purchase price of the goods and/or services purchased by the store customer is reduced by an amount of the purchase value shown on the game card. Alternatively, a scratch-off type game card can be handed to the store customer instead of the electronically printed ticket.

### BACKGROUND OF THE INVENTION

Field of the Invention

The invention relates, generally, to a game card based business method, and more specifically, it relates to a method of selling chances to win a free purchase and related advertisement/promotional activity.

There are many different types of ticket, game card or lottery type games and many different forms of state-run and nationally-run lotteries that are conducted. In a traditional lottery, in exchange for a comparatively small wager, typically one dollar, a customer can select lottery numbers and purchase a lottery ticket having a chance to win a jackpot or other prize. Although the number of lottery tickets sold to customers may ultimately determine an amount of a jackpot, players currently only have limited ways in which to directly influence a game's outcome or their likelihood of winning during any one particular contest. Additionally, organizations offering traditional lottery games typically execute drawings once or twice per week. This infrequency of opportunity can sometimes lead to a lapse in lottery ticket sales, particularly during extended times when jackpots fail to exceed certain thresholds, and consequently do not motivate sales among people who typically would not play.

Another type of game is the instant ticket or “scratch-off” game by which players may receive payouts immediately. This style of game typically involves a purchase of a paper or cardboard game card. In most cases, a player, to reveal combinations of symbols or values, actively uncovers or exposes a portion, selection, or element of the game card concealed by a latex covering or other removable covering. Certain combinations of symbols or values correspond to prizes, which may be paid out to a player at any participating gaming merchant.

The majority of lottery tickets are sold by grocery, liquor and convenience stores. These retail stores typically place a dedicated lottery terminal away from one or more point of sale (POS) terminals used for merchandise transactions. The physical separation is to ensure that the merchandise transaction line is not slowed-down or blocked by customers wishing to make lottery ticket purchases only. In addition, since the lottery terminals have a separate and distinct accounting system, there is no need to co-locate the POS terminals and dedicated lottery terminals.

However, some customers may consider it annoying to make two separate transactions, i.e. merchandise and lottery tickets, on two different terminals within the same store. Separate terminals may also force the customers to wait in two separate lines, or may slow down the overall merchandise checkout procedure while a single store clerk performs two separate transactions on two terminals. Besides annoying the merchandise-only customers, these inconveniences also reduce the impulse purchasing of lottery tickets, which in turn leads to loss of revenue for the government and the store.

There are other disadvantages with using two-separate and distinct terminals for merchandise transactions and lottery ticket transactions. The government usually bears the costs of purchasing, leasing, installing and maintaining the dedicated lottery terminals. There are also the considerable costs of resupplying the lottery ticket paper and ink for each dedicated lottery terminal. Moreover, many retail stores with multiple checkout lines and registers, such as supermarkets, do not have the resources to support dedicated lottery terminals at every check-out register. In addition, a dedicated lottery terminal uses counter space that could otherwise be devoted to revenue-producing merchandise displays. It is also costly to train store personnel in the operation of two distinct types of transaction terminals. These factors reduce the availability of lottery tickets to consumers, and thus reduce governmental revenue, by limiting the number of locations that sell lottery tickets.

Furthermore, there is no advertising benefit derived from such government run lottery games that directly benefit a particular store over other stores providing such lottery games. This is a lost benefit as an individual store or chain may wish to have localized advertising on the game cards but this is not possible for government ran lotteries.

### SUMMARY OF THE INVENTION

It is accordingly an object of the invention to provide a game card based business method, which overcomes the herein-mentioned disadvantages of the heretofore-known methods of this general type.

With the foregoing and other objects in view there is provided, in accordance with the invention, a game card based promotional business method. The method includes printing game cards each containing indicia indicative of a winning status. The indicia are covered with an opaque covering surface that must be removed for revealing the winning status. The game cards are sold to a vendor selling goods. One of the game cards is combined with one of the goods to be sold by the vendor. The goods are sold to a store for retail sale to a customer. The customer accesses a respective game card after a respective good has been initially entered at a checkout register. The winning status of the respective game card is ascertained and a winning game card is exchangeable as payment for the respective good. The winning game card is then used as payment for the respective good. In this manner, the distributor of the goods/services individually or in conjunction with stores can use the game card based game as a promotional activity for selling its goods and services.

In accordance with an added mode of the invention, there is the step of inserting the respective game card into packaging containing the respective good.

In accordance with an additional mode of the invention, there are the steps of selling the games cards from a game card distributor to the vendor selling goods, sending the winning game card to the game card distributor, and reimbursing the store for a purchase price of the respective good.

In accordance with a further mode of the invention, there are the steps of forming the opaque covering surface to be removable by being scratched, and invalidating the respective game card if the opaque covering surface is at least partially removed before a purchase has been initially entered. Ideally, the respective game card is scratched at a checkout counter of the store by a cashier or in view of the cashier. Furthermore, the respective game card is formed with advertising material specifically related to one of the vendor and the store. For instance, the game card is formed as a coupon or an advertisement.

Alternatively the indicia can be electronically encoded on the game card. The indicia identify the respective good and its purchase value. The encoded indicia are read with a game card reader for ascertaining the winning status of the game card.

With the foregoing and other objects in view there is further provided, in accordance with the invention, a method for conducting a promotional game. The method includes printing game cards each containing indicia indicative of a purchase discount. The indicia are covered with an opaque covering surface that must be removed for revealing a value of the purchase discount. A respective game card is given to each store customer. The opaque covering surface is removed after a purchase has been initially entered and a purchase price is discounted by an amount of the purchase discount noted on the respective game card. The purchase discount can range from 1% to 100%.

Instead of being covered, the indicia can be encrypted into the game card to be read by a game card reader. Of course a respective game card is invalidated if the game code reader cannot read the encoded indicia or detects a manipulation of the encoded indicia. The game card is read at a checkout counter of the store by a cashier or the customer is allowed to swipe the respective game card through the game card reader. This allows more participation by the customer and provides a feeling of involvement.

The game cards can be sold or simply given to the customers as a promotional inducement for coming to the store.

With the foregoing and other objects in view there is provided, in accordance with the invention, a game card based promotional business method. The method includes ringing up a purchase of goods and/or services being purchased by a store customer. A game card is sold to the store customer as a last item rung up for the store customer. The game card is electronically printed and contains indicia indicative of a purchase value. Preferably, the game cards are printed by the cash register. The game card is then given to the store customer for ascertaining if the game card is a winning game card. A purchase price of the goods and/or services purchased by the store customer is reduced by an amount of the purchase value shown on the game card. The sale of the game card is electronically credited to a game card distributor. For example, this occurs on-line over the Internet or stored in the cash register for later access and removal. More specifically a value or percentage thereof of the purchase price is transmitted to the game card distributor. Also the store is electronically reimbursed for the purchase price exchanged for a winning game card.

The indicia can be cover with an opaque covering surface to be removed by being scratched or the indicia is encoded into the game card. The encoded indicia are read by a game card reader. The game card is redeemable for the purchase price or it is set to a given limit (e.g. $1,000.00). Preferably, the game card reader and printer are integrated together and with the cash register. Alternatively, the components can be stand alone if necessary or combination of the components.

Other characteristic features of the invention are set forth in the appended claims.

Although the invention is illustrated and described herein as embodied in a game card based business method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of specific embodiments when read in connection with the accompanying drawings.

### BRIEF DESCRIPTION OF THE DRAWINGS

FIG. 1 is a flow chart describing a first embodiment of a business method according to the invention;

FIG. 2 is a flow chart describing a second embodiment of the business method according to the invention;

FIG. 3 is a flow chart describing a third embodiment of the business method according to the invention;

FIG. 4 is a flow chart describing a fourth embodiment of the business method according to the invention; and

FIG. 5 is a flow chart describing a fifth embodiment of the business method according to the invention.

### DESCRIPTION OF THE PREFERRED EMBODIMENTS

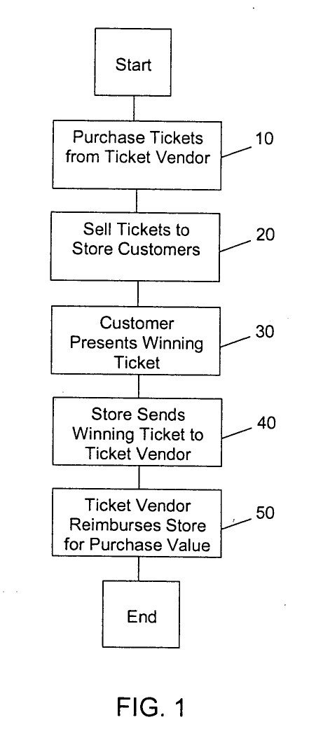

Referring now to the figures of the drawings in detail and first, particularly, to FIG. 1 thereof, there is shown a flow diagram of a game card based business method.

The overall concept of the invention relates to selling chances to win a full or partial rebate on purchases at a participating retail store or vendor. The tickets or game cards are purchased, verified for a winning status, and redeemed, if applicable. A winning ticket allows the holder to present the winning ticket as payment in full for the merchandise processed by a checkout clerk. The purchase price of the ticket is automatically credited to a ticket redemption center (e.g. ticket vendor) or the tickets are prepurchased by the store owner from a ticket vendor. The store owner in turn sends a winning ticket with an applicable receipt to the ticket redemption center for reimbursement for the receipt or the redemption is electronically transmitted in an automated system.

FIG. 1 shows a first example of the ticket or game card based business method. In step 10, tickets or game cards (hereinafter both are referred to as tickets) are sold from a ticket vendor to a particular store(s). A single store is used for exemplary purposes only and it need only be mentioned that any chain of stores or multiple different stores can participate. In step 20, the store sells the tickets to its customers at the checkout counter after a merchandise purchase has been rung up. The ticket will be the last product rung up on the bill. The customer in conjunction with the checkout clerk immediately verify the winning status of the ticket (e.g. a scratch off type ticket). In step 30, if the ticket is identified as a winning ticket, the customer presents the ticket to the cashier and the winning ticket is recognized as full payment for the merchandise/services presented by the customer to the cashier. The store in turn sends the winning ticket along with the purchase receipt for payment to the ticket vendor for redemption in step 40. In step 50, the ticket vendor sends a reimbursement payment for reimbursing the store for the value of the merchandise/services received by the customer who purchased the winning ticket.

Alternatively, this whole process can be performed electronically. Instead of purchasing individual tickets from the ticket vendor, the tickets are sold electronically. Upon ringing up the purchase of the ticket by a customer, an electronic credit is sent to the ticket vendor. The merchandise purchase receipt functions as the ticket in which it indicates a winning status or provides a scratch off section at the bottom of the receipt for determining the winning status of the ticket. Because the winning status of the ticket is already known, the store is automatically reimbursed for winning tickets. In this manner, accounting is simplified and no paper invoices are necessary.

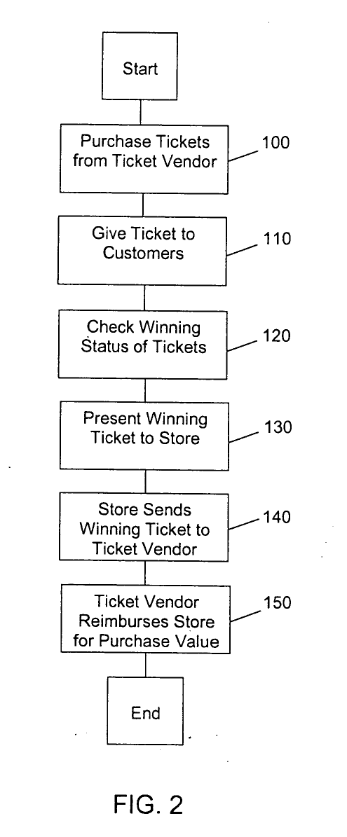

FIG. 2 shows a second embodiment of the game card based business method. In step 100, tickets are sold from a ticket vendor to a particular store(s). In step 110, the store gives out the tickets to the customer at the checkout counter, at no cost, after the merchandise has been rung up. The ticket will be the last product rang up on the bill but shown as a no cost item to the customer. The customer then checks the ticket for its winning status (e.g. a scratch off type ticket) in conjunction with the checkout clerk, step 120. In step 130, if the ticket is a winning ticket, the customer presents the ticket to the checkout clerk in lieu of payment and leaves with the procured merchandise/services. The store in turn sends the winning ticket along with the receipt for payment to the ticket vendor for redemption in step 140. In step 150, the ticket vendor sends a reimbursement payment for the value of the merchandise/services received by the customer who purchased the winning ticket.

In these scenarios the store and the ticket vendor obtain multiple benefits. First, the store creates an advertising inducement for drawing in customers to the store. Second, as a result of the increased traffic flow the store increases it sales. Third, the store may share in the profits from the sale of tickets to the customers. Fourth, the ticket vendor profits from the sale of the tickets to the store. Fifth, the ticket itself may contain other advertising indicia benefiting the store. For example the ticket can function as a coupon or providing other advertising type material.

As in FIG. 1, this method could also be fully implemented electronically.

The first and second embodiments of the game card based business methods shown in FIGS. 1 and 2 can be further modified such that the ticket reimbursement process is the responsibility of the customer rather than the store. In this embodiment, the customer is responsible for sending the ticket and the associated receipt to the ticket vendor for receiving the reimbursement payment. Of course in this scenario, an integrated, electronically generated ticket/sales receipt is preferred over a scratch off type ticket for security and validation purposes. For enhanced security, the winning amount could be encrypted on a scratch off type ticket by the store. One of the main benefits from this scenario is the reduced work load put on the store which in the first and second scenarios would be responsible for forwarding the tickets to the ticket vendor for receiving a reimbursement for winning tickets.

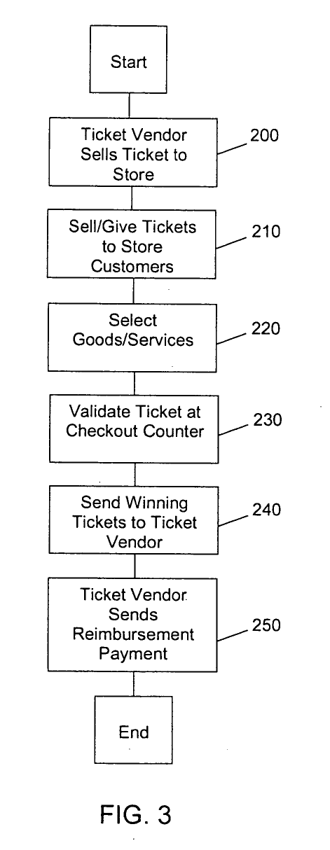

A third embodiment of the game card based business method is shown in FIG. 3. In step 200, the ticket vendor sells tickets to a store. The store in turn sells or gives the tickets to its customers as they enter the store (e.g. by a greeter at the entrance), by a cashier at the checkout counter, or any other desirable spot in the store, step 210. All tickets are winners in that they provide a discount for any products or services purchased that day in the store. The degree of discount can vary from one ticket to the next (e.g. 1, 2, 3, 4, 5, 10, 15, 20, 25 . . . 100% off). In addition to providing a discount, the ticket can also provide a chance at not having to pay the bill or a 100% discount. After a customer has selected his goods and services (step 220), the customer heads for the checkout counter with the ticket in hand. For control purposes the tickets can only be checked or scratched by checkout personal at the checkout counter in order to receive the appropriate discount, step 230. If the customer wins a full 100% discount, the customer presents the winning ticket in lieu of payment and leaves the store with his/her goods and/or services. In all cases, the customer will at least receive a discount on the purchase and in essence there are no losers and only winners. In turn the store sends the winning tickets to the ticket vendor for reimbursement, step 240. The ticket vendor in turn reimburses the store for the purchase value of the goods/services received by the customer, step 250. Of course most tickets will only provide a small discount of 5 or 10% and these tickets cannot be sent for reimbursement. The threshold for the winning discounts and any limit on the total purchase amount are prearranged between the store and the ticket vendor. Of course the 100% discount may also be limited with a threshold amount (e.g. 100% of purchase up to a maximum value of $1,000).

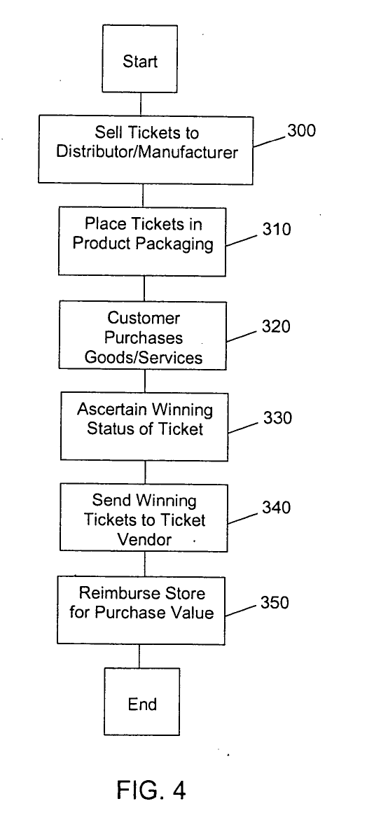

A fourth embodiment of the invention is described using the flow chart shown in FIG. 4. In this scenario, three participants are involved, a store, a product (and/or service) distributor/manufacturer, and a ticket vendor. Tickets are sold to the distributor/manufacturer of goods and/or services, step 300. In order to promote specific merchandise or services, tickets are placed in the packaging of the goods and/or services sold by the distributor or manufacturer, step 310. The distributor/manufacturer advertises that his goods and/or services carry game cards that may be immediately redeemed for the purchase price of the goods and/or services. In holding with the advertising concept, the tickets in this scenario may be given a name, e.g. Good Buy Bill game cards, in order to facilitate name recognition of the ticket vendor and/or the product distributor/manufacturer. A customer selects an item containing the Good Buy Bill game card and presents the item to the checkout clerk for processing, step 320. After the good(s) advertised to carry the Good Buy Bill game card are rung up, the customer can open the packaging to obtain the Good Buy Bill game card for ascertaining whether he/she has won an instant 100% rebate on the purchase price for that particular item, step 330. The rebate is then entered and discounted from the bill of the customer or a cash payment is made. The store in turn submits the Good Buy Bill game card to the ticket vendor for reimbursement, step 340. In turn, the ticket vendor reimburses the store for the value of the purchased item, step 350.

In this scenario, one does not deal with individual storeowners, but rather manufactures and distributors who may wish to engage in such an advertising process in order to increase sales. In this way a second group of customers is targeted by the game card based business method.

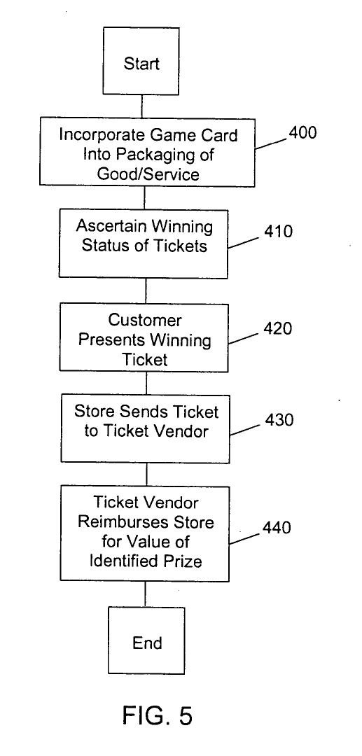

A fifth embodiment of the invention is described in FIG. 5. In this embodiment, the winning ticket or Good Buy Bill game card is formed into the product itself or the product packaging, instead of a ticket being inserted into the packaging. For example, a pack of gum contains a plurality of individual sticks and the ticket is incorporated into one or all of the individual sticks of gums or the gum packaging containing the sticks of gum, step 400. In this scenario we will assume the gum packaging incorporates (e.g. the packaging has the ticket imprinted thereon) the Good Buy Bill ticket. The ticket provides a chance to win a discount on all purchases, an unlimited full purchase of products/services, a gift certificate for a given quantity, or to win the purchase of that particular product (e.g. the pack of gum). The customer first purchases the product at the checkout counter, and after purchasing the product, ascertains the winning status of the ticket (e.g. unwraps the gum packaging), step 410. The customer obtains the benefits of any prize listed on the wrapper by presenting the ticket to the cashier and receives the benefit of the identified prize, step 420. The store in turn sends the winning ticket to the ticket vendor along with the receipt for a reimbursement payment, step 430. In turn, the ticket vendor reimburses the store for the value of the identified prize, step 440. The example of a pack of gum is merely illustrative and many products could be used. However, products that can be purchased on impulse and in close proximity to the checkout counter are preferred. Ideally, the product containing the ticket is rung up last in a purchase and may be imprinted with a warning bar code signal for assisting the cashier in making sure that the ticket type product is rung up last (e.g. the cashier must manually strike an enter or cancellation key after the bar code is read for entering or canceling the sale). If the cashier enters a cancel code, the product is placed to the side and reentered again at the end of the ringing up process to help assure that it is the last product rung up.

The above described tickets are described as “scratch off” type tickets. The invention is not limited to this type of ticket and can include but not limited to electronic tickets and encrypted tickets. The limit on the ticket is only a matter of security, fraud prevention, accounting and inventory control. For instance, the indicia written on a game card indicating the winning prize can be written in encrypted form to be read by a game card reader.

In addition, the type of ticket or packaging involved also limits the physical form of the ticket. In addition, the concept of a ticket is not limited to a game card but any media capable of indicating a winning status and related prize is acceptable and optionally may contain a removable cover.

1. A game card based promotional business method, which comprises the steps of:
printing game cards each containing indicia indicative of a winning status, the indicia being covered with an opaque covering surface which must be removed for revealing the winning status;
selling the game cards to a vendor selling goods;
combining one of the game cards with one of the goods to be sold by the vendor;
selling the goods to a store for retail sale to a customer;
allowing the customer to access a respective game card after a respective good has been initially entered at a checkout register;
ascertaining the winning status of the respective game card for identifying a winning game card being exchangeable as payment for the respective good; and
exchanging the winning game card as payment for the respective good.

2. The method according to claim 1, which further comprises inserting the respective game card into packaging containing the respective good.

3. The method according to claim 1, which further comprises:
selling the games cards from a game card distributor to the vendor selling goods;
sending the winning game card to the game card distributor; and
reimbursing the store for a purchase price of the respective good.

4. The method according to claim 1, which further comprises:
forming the opaque covering surface to be removable by being scratched; and
invalidating the respective game card if the opaque covering surface is at least partially removed before a purchase has been initially entered.

5. The method according to claim 4, which further comprises permitting the respective game card to be scratched at a checkout counter of the store by a cashier.

6. The method according to claim 1, which further comprises forming the respective game card with advertising material specifically related to one of the vendor and the store.

7. A game card based promotional business method, which comprises the steps of:
printing game cards each containing indicia indicative of a winning status, the indicia being electronically encoded;
selling the game cards to a vendor selling goods;
combining one of the game cards with one of the goods to be sold by the vendor selling goods;
selling the goods to a store for retail sale to a customer;
allowing the customer to access a respective game card after a respective good has been initially entered at a checkout register;
ascertaining the winning status of the respective game card for identifying a winning game card being exchangeable as payment for the respective good; and
exchanging the winning game card as payment for the respective good.

8. The method according to claim 7, which further comprises inserting the respective game card into packaging containing the respective good.

9. The method according to claim 7, which further comprises:
selling the games cards from a game card distributor to the vendor selling goods;
sending the winning game card to the game card distributor; and
reimbursing the store for a purchase price of the respective good.

10. The method according to claim 7, which further comprises reading the encoded indicia with a game card reader for ascertaining the winning status of the game card.

11. The method according to claim 7, which further comprises:
encoding the indicia to identify the respective good and its purchase value; and
forming the game cards with advertising material specifically related to one of the vendor and the store.

12. A method for conducting a promotional game, which comprises the steps of:
printing game cards each containing indicia indicative of a purchase discount, the indicia being covered with an opaque covering surface which must be removed for revealing a value of the purchase discount;
providing a customer at a store with a respective game card;
permitting a removal of the opaque covering surface after a purchase has been initially entered; and
discounting a purchase price by an amount of the purchase discount noted on the respective game card.

13. The method according to claim 12, which further comprises providing the customer with the respective game card at an entry point to the store.

14. The method according to claim 12, which further comprises providing the customer with the respective game card at a checkout point in the store.

15. The method according to claim 12, which further comprises selecting the purchase discount from a range of 1% to 100%.

16. The method according to claim 15, which further comprises:
selling the games cards from a game card vendor to the store;
sending the game cards to the game card vendor for reimbursement of winning game cards showing the purchase discount to be equal to or greater than a given threshold value; and
reimbursing the store for an amount relating to the purchase discount shown on the winning game cards.

17. The method according to claim 12, which further comprises:
forming the opaque covering surface to be removable by being scratched; and
invalidating the respective game card if the opaque covering surface is at least partially removed before the purchase has been initially entered.

18. The method according to claim 17, which further comprises permitting the respective game card to be scratched at a checkout counter of the store by a cashier.

19. The method according to claim 12, which further comprises forming the game cards with advertising material specifically related to the store.

20. A method for conducting a promotional game, which comprises the steps of:
printing game cards each containing indicia indicative of a purchase discount, the indicia being encoded into the game cards;
providing a customer at a store with a respective game card;
reading the encoded indicia after a purchase has been initially entered; and
discounting a purchase price by an amount of the purchase discount noted on the respective game card.

21. The method according to claim 20, which further comprises providing the customer with the respective game card at an entry point to the store.

22. The method according to claim 20, which further comprises providing the customer with the respective game card at a checkout point in the store.

23. The method according to claim 20, which further comprises selecting the purchase discount from a range of 1% to 100%.

24. The method according to claim 23, which further comprises:
selling the games cards from a game card vendor to the store;
sending the game cards to the game card vendor for reimbursement of winning game cards showing the purchase discount to be equal to or greater than a given threshold value; and
reimbursing the store for an amount relating to the purchase discount shown on the winning game cards.

25. The method according to claim 20, which further comprises:
reading the encoded indicia with a game card reader; and
invalidating the respective game card if the game code reader cannot read the encoded indicia or detects a manipulation of the encoded indicia.

26. The method according to claim 25, which further comprises reading the game card at a checkout counter of the store by a cashier.

27. The method according to claim 25, which further comprises allowing the customer to swipe the respective game card through the game card reader.

28. A method for conducting a promotional game, which comprises the steps of:
printing game cards each containing indicia indicative of a purchase value, the indicia being covered with an opaque covering surface which must be removed for revealing the purchase value;
selling the game cards to a store;
reselling a respective game card to a store customer;
reading the respective game card for determining if the respective game card is a winning game card; and
reducing a purchase price of the goods and/or services purchased by the store customer by an amount of the purchase value shown on the respective game card.

29. The method according to claim 28, which further comprises:
selling the games cards from a game card distributor to the store;
sending the winning game card to the game card distributor; and
reimbursing the store for the purchase value exchanged for the winning game card.

30. The method according to claim 28, which further comprises forming the opaque covering surface to be removable by being scratched.

31. The method according to claim 28, which further comprises:
forming the respective game card with advertising material specifically related to the store; and
forming the respective game card as a coupon.

32. The method according to claim 28, which further comprises limiting the purchase value to a given amount.

33. The method according to claim 28, which further comprises setting the purchase value to be equal to the purchase price of the goods and/or services rung-up.

34. A method for conducting a promotional game, which comprises the steps of:
printing game cards each containing indicia indicative of a purchase value, the indicia being covered with an opaque covering surface which must be removed for revealing the purchase value;
selling the game cards to a store;
giving a respective game card to a store customer;
reading the respective game card for determining if the respective game card is a winning game card; and
reducing a purchase price of goods and/or services purchased by the store customer by an amount of the purchase value shown on the respective game card.

35. The method according to claim 34, which further comprises:
selling the games cards from a game card distributor to the store;
sending the winning game card to the game card distributor; and
reimbursing the store for the purchase value exchanged for the winning game card.

36. The method according to claim 34, which further comprises forming the opaque covering surface to be removable by being scratched.

37. The method according to claim 34, which further comprises limiting the purchase value to a given amount.

38. The method according to claim 34, which further comprises setting the purchase value to be equal to a purchase price of the goods and/or services rung-up.

39. The method according to claim 34, which further comprises giving the respective game card to the customer after the goods and/or services have been rung up.

40. A method for conducting a promotional game, which comprises the steps of:
printing game cards each containing indicia indicative of a purchase value, the indicia being covered with an opaque covering surface which must be removed for revealing the purchase value;
selling the game cards from a game card distributor to a store;
reselling a respective game card to a store customer;
ascertaining if the respective game card is a winning game card;
sending the winning game card from the store customer to the game card distributor; and
reimbursing the store customer for the purchase value of the winning game card.

41. A method for conducting a promotional game, which comprises the steps of:
ringing up a purchase of goods and/or services being purchased by a store customer;
selling a game card to the store customer as a last item rung up for the store customer;
electronically printing the game card containing indicia indicative of a purchase value;
giving the game card to the store customer;
ascertaining if the game card is a winning game card; and
reducing a purchase price of the goods and/or services purchased by the store customer by an amount of the purchase value shown on the game card.

42. The method according to claim 41, which further comprises electronically crediting a sale of the game card to a game card distributor.

43. The method according to claim 42, which further comprises:
transmitting a value of the purchase price to the game card distributor; and
electronically reimbursing the store for the purchase price exchanged for the winning game card.

44. The method according to claim 41, which further comprises covering the indicia with an opaque covering surface to be removable by being scratched.

45. The method according to claim 41, which further comprises:
encoding the indicia on the game card; and
reading the encoded indicia with a game card reader.

46. The method according to claim 41, which further comprises limiting the purchase value to a given amount.

47. The method according to claim 41, which further comprises setting the purchase value to be equal to a purchase price of the goods and/or services rung-up.

48. The method according to claim 46, which further comprises integrating the game card reader with a printer printing the game card.
